(19) United States
(12) Patent Application Publication
(10) Pub. No.: US 2008/0320477 A1
(43) Pub. Date: Dec. 25, 2008

(54) METHOD FOR SCHEDULING AND CUSTOMIZING SURVEILLANCE TASKS WITH WEB-BASED USER INTERFACE

(76) Inventor: Mariann Meeks, Rancho Mirage, CA (US)

Correspondence Address: LAW OFFICES OF DUANE P. STONE, P.C., 8 N. BALTIMORE ST., DILLSBURG, PA, 17019, US

(21) Appl. No.: 11/765,717

(22) Filed: Jun. 20, 2007

(51) Int. Cl. G06F 9/46

(52) U.S. Cl. 718/102

(57) ABSTRACT

A customized surveillance task management system is implemented to intelligently schedule tasks for the user. Via an internet connection a user accesses a list of surveillances to be accomplished. The schedule of surveillances is created from information initially loaded into a centralized database that is subsequently analyzed by the schedule engine and written back into the database. Following execution of these surveillances the user again accesses the system to input data acquired. The user then inputs data to the database via the internet interface via preset database fields rendered to the client machine. This data is again analyzed by the scheduling engine and, with the help the scheduling, criticality, random sampling, and surveillance method assistants, provides the user with an updated schedule list and best set of surveillance methods dependent upon pass/fail rates and criticality of failures.

### CROSS REFERENCE TO RELATED APPLICATIONS

This non-provisional application claims the benefit of U.S. Provisional Application No. 60/814,855, filed Jun. 20, 2006.

### FEDERALLY SPONSORED RESEARCH

Not Applicable.

### SEQUENCE LISTING OR PROGRAM

Not Applicable.

### BACKGROUND

The present invention relates to a schedule management system. More specifically, the present invention allows a scheduling entity to set predetermined thresholds for any type of requirement, and via a centralized database and internet interface a user at any location will be able to acquire all scheduled surveillances for a particular time period, and following the surveillance, enter all appropriate information to the database. Furthermore, the novel schedule engine intelligently reads the information input to the database and provides the user with feedback regarding pass/fail rates and criticality of failures as well as scheduling additional surveillances to the database after analyzing this data.

### SUMMARY

The technological advance embodied in this invention is expressed as a tool for use in any industry where a better means is needed for scheduling, data collection and data processing. Where inspections, surveys, maintenance tasks, or inventorying are regularly accomplished, this invention can be implemented to aid the user in monitoring the requirements set forth to better provide a means of tracking passage and failure rates, and monitoring critical areas that may evade the user's notice.

The present invention resides in a network structure and method providing a client with a user-friendly system for scheduling surveillance tasks accessible via web based interface at remote locations. A surveillance task is a quality control and assurance task involving a physical observation of an event in a warehouse, including but not limited to tracking and monitoring of various events. To achieve this objective the invention provides a novel architecture comprised of easily obtainable off-the-shelf hardware components, and novel software method whereby the user can establish pre-determined thresholds for any requirement, and build schedules for each surveillance which are stored in a centralized database. At that point the software method and product become indispensable whereby it intelligently loads surveillances due, and by analyzing the feedback entered by the user following a surveillance, will compile a new schedule based on pass/fail rates and criticality of failures. The invention may provide the client with a graphical display of all upcoming surveillances and intelligently monitor all surveillances and redefine or redistribute the schedule as needed. The present invention integrates client feedback after the completion of any surveillance to produce new, updated schedules for future surveillances based on this feedback. Key requirements are predefined, but may be tailored by the client to emphasize areas of concern that may arise during any inspection, survey, maintenance, or inventory tasks. These key requirements are housed in a centralized database that will be accessible by the client from any location with internet access. The schedule engine in turn reads these requirements, makes changes to the existing record of schedules and propagates these changes back to the database for transmittal to the client.

### BRIEF DESCRIPTION OF THE SEVERAL VIEWS OF THE DRAWING

The drawings presented hereafter are to be used together with the descriptions to explain the inventive aspects of the software, and represent examples of the embodiments herein. The drawings are not to be construed as limiting the invention to only the illustrated and described embodiments.

FIG. 1 is a block diagram that shows the overall system structure and interaction between the components.

FIG. 2 is a block diagram that shows the method involved by which the scheduling engine maintains a working schedule for the client.

FIG. 3 is a block diagram that is an overview of the method used by the internet server user interface.

FIG. 3A is a block diagram that shows a detailed view of the process involved with the Application Start and Initialization sequence.

FIG. 3B is a block diagram that shows a detailed view of the process involved when surveillance records are loaded.

FIG. 3C is a block diagram that shows a detailed view of the process involved in template configuration.

FIG. 3D is a block diagram that shows a detailed view of the process involved in the data entry sequence.

FIG. 3E is a block diagram that shows a detailed view of the method employed by the schedule assistant.

FIG. 3F is a block diagram that details the method employed by the criticality assistant.

FIG. 3G is a block diagram that details the method employed by the random sampling assistant.

### REFERENCE NUMERALS IN DRAWINGS

10 network structure
12 schedule engine
14 database server
16 web server
18 client machine with web browser
20 scheduling entity
22 client
24 schedule engine function—load configuration information
26 schedule engine function—load all active schedules
28 schedule engine function—poll database for schedules due
30 schedule engine function—schedules processed
32 schedule engine function—surveillance record generated
34 schedule engine function—record placed in due table
36 schedule engine function—poll database for schedule changes
38 schedule engine function—propagate changes to schedule list
40 web server function—application start and initialization
42 web server function—surveillance records loaded
44 web server function—template configuration
46 web server function—data entry
48 web server function—schedule assistant
50 web server function—criticality assistant
52 web server function—random sampling assistant
54 web server function—surveillance method assistant
56 start and initialization function—initialize database objects
58 start and initialization function—plug-in initialized
60 start and initialization function—template library initialized
62 start and initialization function—scheduletype loaded
64 start and initialization function—read schedules
66 start and initialization function—schedules to scheduling engine
68 start and initialization function—plug-in enumeration
70 start and initialization function—templates loaded
72 surveillance record load function—display surveillances due
74 surveillance record load function—display surveillances overdue
76 surveillance record load function—display future surveillances
78 surveillance record load function—display other configuration modules
80 template configuration function—display template
82 template configuration function—populate by user
84 template configuration function—save as “configuration”
86 template configuration decision step—attach schedule to configuration
90 template configuration function—display interface
92 template configuration function—populate by user
94 template configuration function—save as schedule configuration
96 template configuration decision step—additional records desired
100 template configuration function—create field requirements
102 data entry function—render main data display
104 data entry function—post data
106 data entry function—data written to database
108 data entry decision step—determine if surveillance failed
112 data entry decision step—determine if follow-up is needed
114 data entry function—create new surveillance record
116 data entry decision step—are attachments to surveillance record desired
118 data entry function—attach file
120 scheduling assistant decision step—determine desired mode
122 scheduling assistant function—surveillance monitoring mode chosen
124 scheduling assistant function—test executed
126 scheduling assistant decision step—pass or fail
128 scheduling assistant function—split schedule
130 scheduling assistant function—create new schedule
132 scheduling assistant function—schedule distribution mode chosen
134 scheduling assistant function—determine all upcoming schedules
136 scheduling assistant function—display graph
138 scheduling assistant function—redefine, distribute as needed
140 criticality assistant function—count number of failures
142 criticality assistant function—translate to weighted score
144 criticality assistant determination—pass or fail
146 criticality assistant function—upgrade to higher criticality level
148 criticality assistant function—remain at same criticality level
150 random sampling assistant function—create pass/fail table
152 random sampling assistant function—define size and count
154 random sampling assistant function—assign to table
156 random sampling assistant function—generate randomized numbers
158 random sampling assistant function—link to surveillance

### DETAILED DESCRIPTION OF THE INVENTION

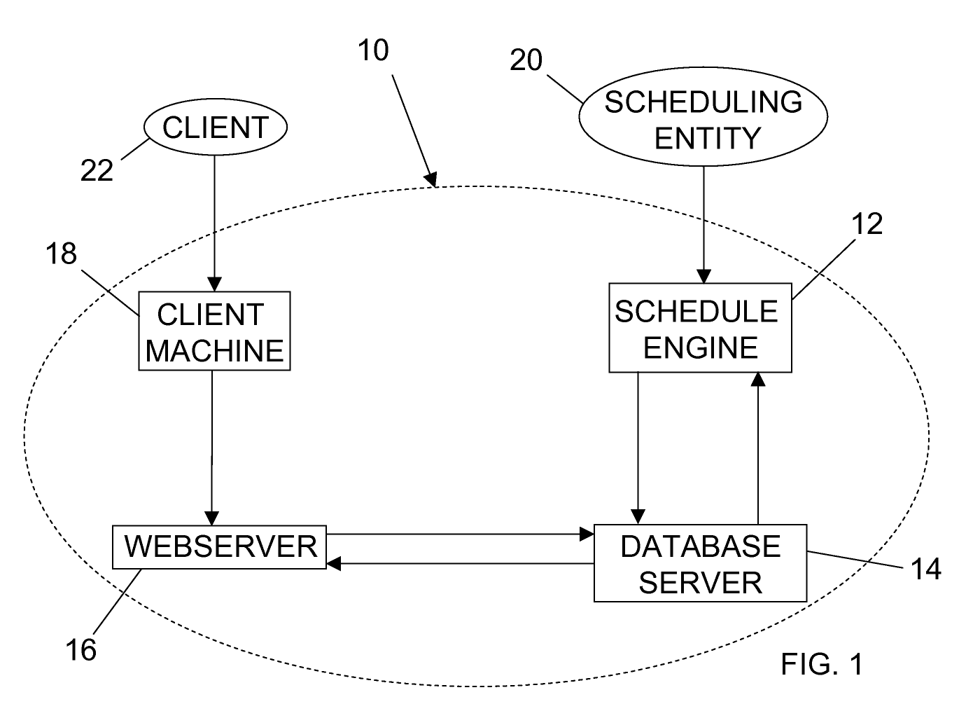

### Description—FIGS. 1-3G

This invention provides a computer structure and method for collecting, distributing and maintaining a customized list of scheduled tasks along a network. A network structure 10 which comprises the invention is shown in FIG. 1. The network 10 is made up of a schedule engine 12, a database server 14, a web server 16, and a client machine with web-browser 18 and is accessed for reasons to be explained below by a scheduling entity 20 and a client 22. The schedule engine 12 is executable on any x86 operating system that supports the 2.0.NET framework and can run headless with no keyboard, mouse or monitor. The database server 14 is executable on a server running an x86 central processing unit (CPU) with the following system requirements: (1) Windows server 2003 or higher, (2) Microsoft SQL server 2005, (3) Ethernet connection, and (4) a potential headless configuration. The web server 16 is executable on a server with an x86 compatible CPU with the following system software requirements: (1) Windows server 2000 or higher, (2) IIS6, (3) ASP .NET 2.0, (4) Ethernet connection, and (5) a potential headless configuration. The web browser 18 requires Internet Explorer 6.0 or higher, with an Ethernet connection to the web server 16 and includes a manually operated keyboard and mouse. The scheduling entity 20 can be represented by, among other parties, the developer or the client. The scheduling entity 20 will interface with the database server 16 via the user's account access to either initially populate the surveillance tasks into the database server 16, or to add, edit, update, or generally maintain the associated schedules. The client 22 will access the client machine with web-browser 18 to monitor and maintain the surveillances scheduled.

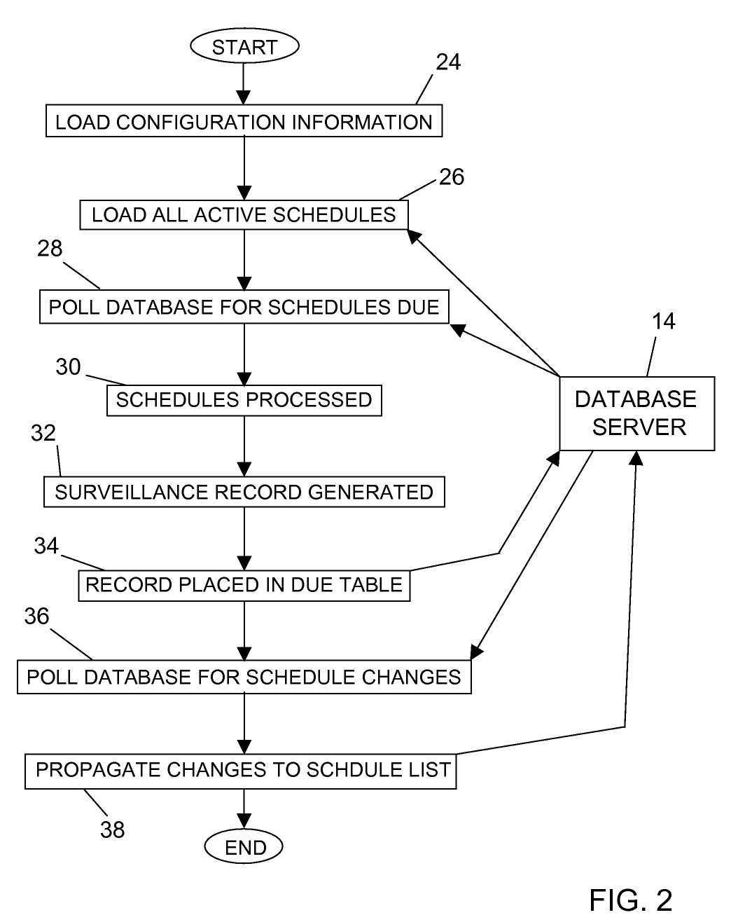

The schedule engine maintains a working schedule available to the client by employing the method shown in FIG. 2. The schedule engine is responsible for generating records which are processed by the web application and presented to the client. These schedules are then processed by the schedule engine to determine a prioritized listing of surveillances to be accomplished. The scheduling entity loads configuration information 24 to the schedule engine including but not limited to: (1) the database with which to connect, and (2) polling intervals, and then logs these settings. Next, the schedule engine obtains all active schedules 26 from the database server 14 if available, and then the database server 14 is then polled for schedules due 28. This service then maintains a list of all active schedules, which have been integrated with information including a specific time and date for execution. If the IsDue function returns “True” then the schedule is currently due, except for the situation where a current surveillance has not been accomplished. A second surveillance is not due if the previous surveillance has not been accomplished. All schedules returned as being due are processed 30 and a surveillance record is generated 32 and placed in the due table 34. Each schedule has an associated template which defines the fields and default values. When a surveillance record is generated it is in turn associated with the aforementioned template. Last-run information is then written to the schedule and the template records. The database server 14 is then polled for any schedule changes 36. The time interval for these pollings can be pre-configured by the scheduling entity 20. If modifications to the schedule are recognized, these changes are propagated into the loaded schedule list to provide the most current list of needed surveillances possible. Any updated records received by this polling are reloaded from the database 14 and replace the currently loaded records with matching schedule identifiers. An earlier date in the “LastUpdated” field gives that surveillance priority upon the execution of each polling 36. The Services Last Update Poll is then reset to the time of the polling.

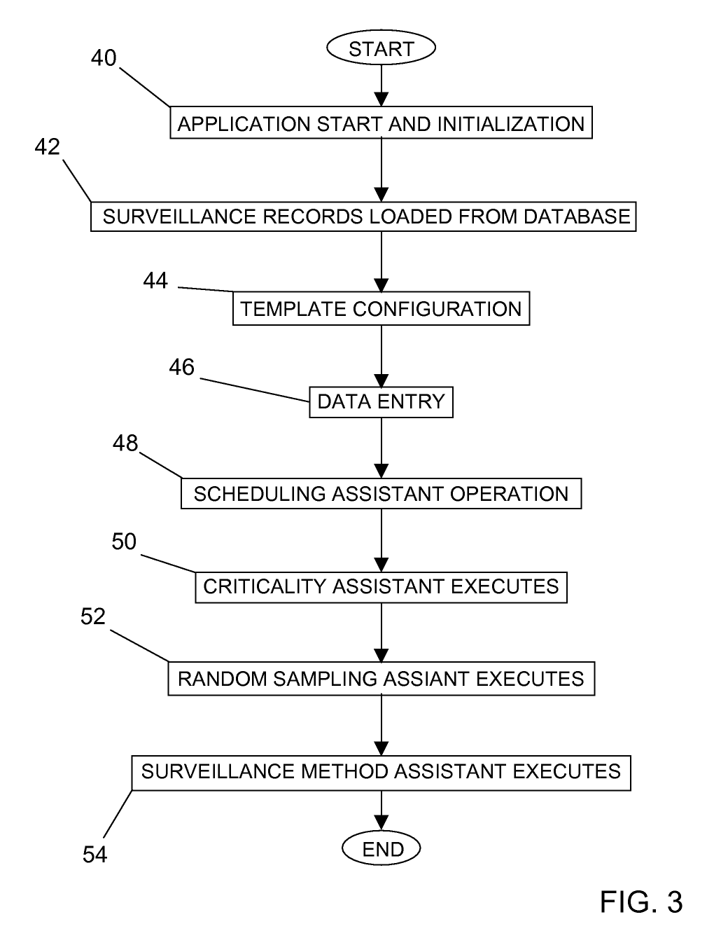

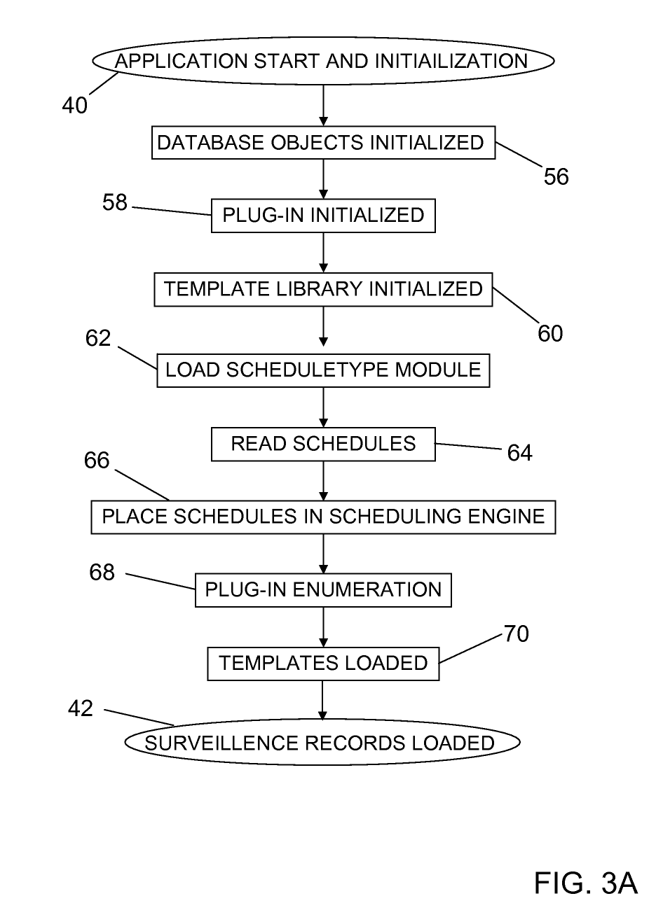

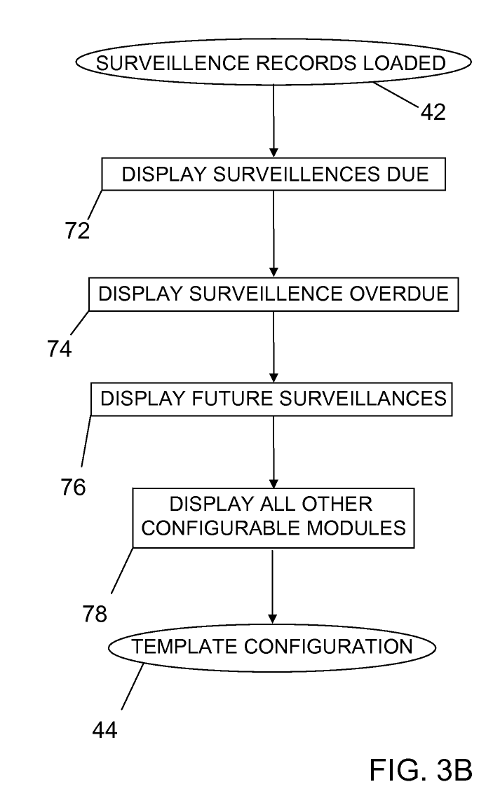

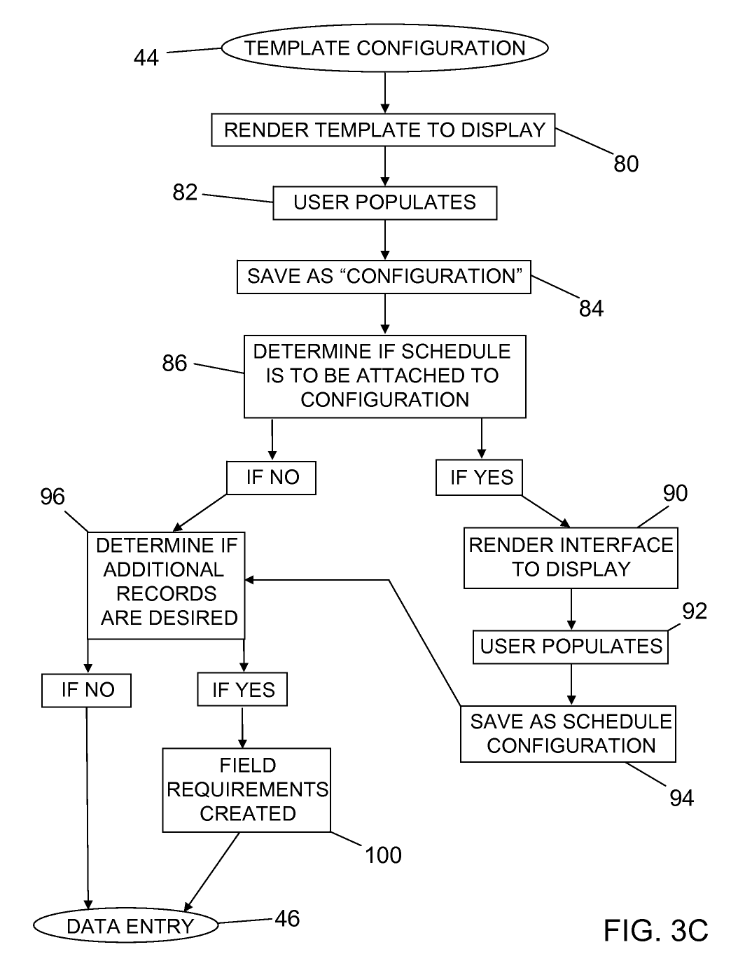

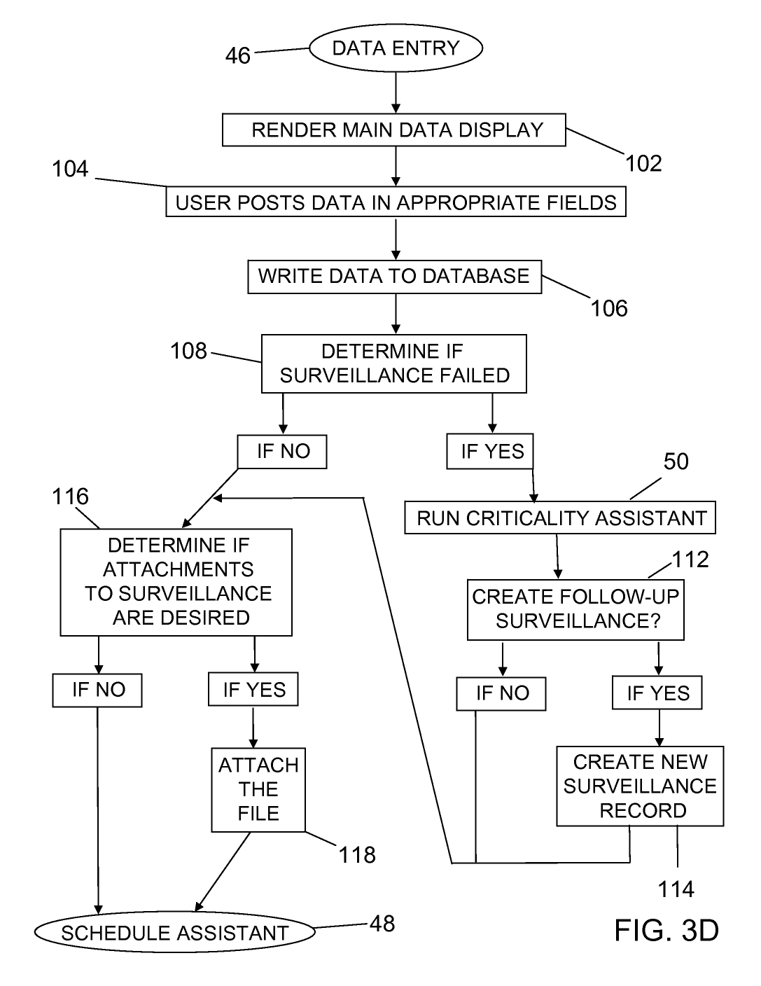

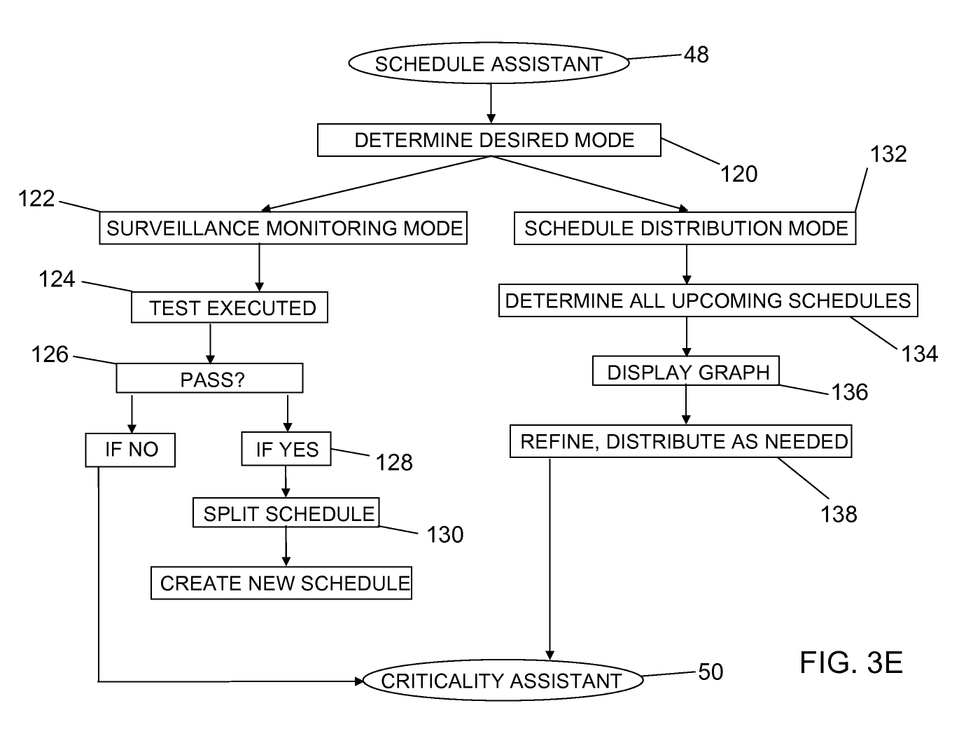

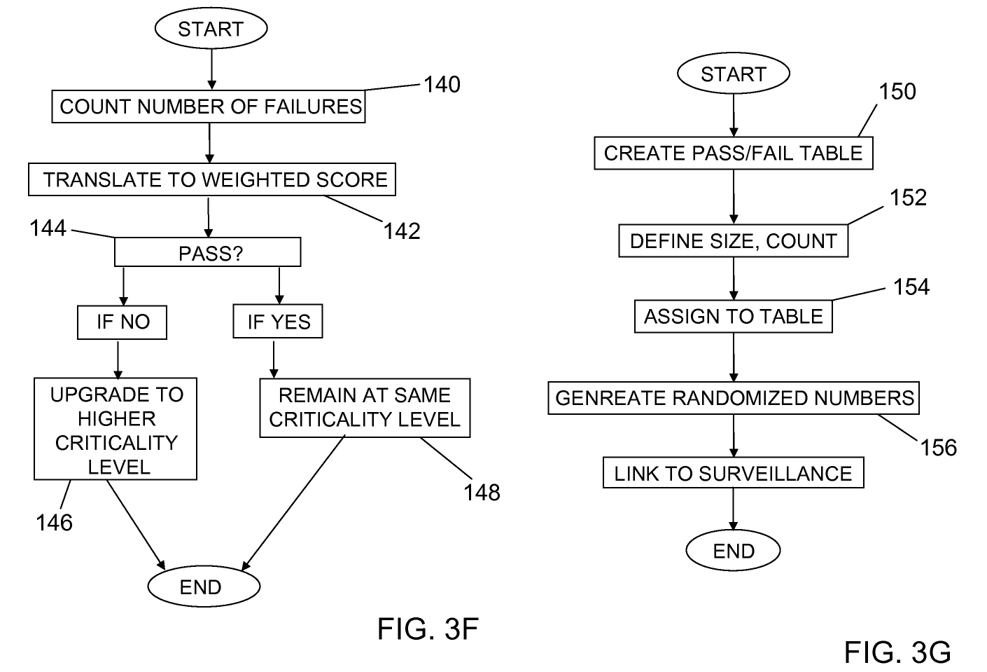

FIG. 3 details the major process components that are executed by the webserver 16 in its (1) management and scheduling of surveillance tasks, and (2) in providing an easily interpreted format to the user. After application start and initialization 40, surveillance records are then loaded from the database server 14, which were previously generated by the schedule engine 12. Following the loading of these surveillance records 44, the template must be configured by the user 42, which is either loaded from default settings, or from settings arranged by the scheduling entity 20. Additional fields may be set at this time by the client. After the template has been configured for the client's needs and following any completed surveillance, the client will then enter the data 46 into the appropriate field within the template. Additional information may be added as an attachment for each surveillance. Following data entry 46, the schedule engine 12 executes the scheduling assistant 48 that assists the client in managing their scheduled surveillance in a more efficient and effective manner. This valuable management tool works to either provide a graphical display of daily surveillance action, or to provide a useful tool in varying the frequency of surveillance activity. Next, a criticality assistant executes 50 to provide the client 22 with areas within a surveillance which need special attention. This draws the client's attention to areas of past failures and assigns a value to the criticality of the failure. Following the execution of the criticality assistant 50, the random sampling assistant is run 52. This invaluable tool allows the client to see pass/fail rates of previously accomplished surveillance tasks. Finally, the surveillance method assistant executes 54, which is available to guide the client 22 through a simple flowchart to determine the best set of surveillance methods which should be utilized.

FIGS. 3A-3G detail the processes contained within the aforementioned major process steps executed by the webserver (see FIG. 3). To completely understand steps 40-54 contained within FIG. 3, FIGS. 3A-3G where developed to shed light on the steps each component executes in providing the client with this unique and highly useful scheduling and surveillance management tool.

With reference to FIG. 3A, the application start and initialization sequence 40 involves loading and configuring the webserver 16 and client machine 18 for use. Specifically, the process begins by initializing database objects with connection strings 56. Next, the plugin and template libraries are initialized 58 with the path of the plugin and template locations. The plug-in and template directories are located in the /bin directory at the root of the website on the Web Server. A template area actually a specialized form of a plug-in (a “sub class” of the “BasePlugin” Class from which all plug-ins are derived). The Scheduletype modules are loaded 62 into the schedule engine 22. Schedules are then read 64 from the database by the webserver which is in turn transferred to the schedule engine 22. Then, plugins are enumerated from the plugin directory 66, and the plugin's initialization function is called with a pointer to the configuration data held by the webserver 16. Templates are then loaded from the template directory 70. This finalizes the application start and initialization.

With reference to FIG. 3B, following application start and initialization 40, surveillance records are loaded from the database 42 from records generated by the schedule engine 12. Any and all surveillances currently due are displayed in a table on the primary client web-interface 72, as well as any overdue schedules 74 that are recognized by the schedule engine 12. Additionally, future surveillances are displayed 76. Finally, all information input by the client, or any configurable display modules configured by the client are then displayed 78 to the client prior to executing a given surveillance. These steps encompass the loading of surveillance records step 42.

With reference to FIG. 3C, template configuration must then be accomplished 44. To begin, the template is rendered to the primary client web-interface 80. Default fields have been established by the software developer, but may be altered and customized at any time by the client 22 or scheduling entity 20. The user will then populate the displayed fields 82 with information obtained from the executed surveillance. The input data is then saved as a “configuration” 84. A decision must now be made by the client; whether it is desired that a schedule be attached to the aforementioned “configuration” 86. The schedule will define how often and precisely when the “configuration” record previously saved is converted into a “surveillance” record by the scheduling engine.

If the schedule is to be attached to the “configuration”, a separate display is rendered to the primary client web-interface 90. The client will populate the predetermined fields 92 rendered from the database, and then are saved as schedule configuration 94.

If no schedule is to be attached to the “configuration”, or after the schedule is attached to the “configuration” 94, the client must determine if additional records are desired 96. If additional records are desired, separate “field” records may be created 100. “Field” records define the field's name in the database, its associated configuration, its data type, its value and other configurable information. If no additional records are desired, or after additional records are created, data entry must be accomplished 46.

With respect to FIG. 3D, when the client 22 returns from executing a scheduled surveillance, the main data entry screen will be rendered for display for the surveillance just completed 102. The display is in read-only mode and is made up of data entry fields defined by that “configuration”, followed by any custom fields defined by the client. Data obtained from the surveillance is written back into the appropriate field by the client 104 and is then written to the database by the webserver 106. A determination is made by the webserver as to whether the surveillance failed by reading the inputted data against the previously established range of acceptable values 108. If the surveillance yielded unsatisfactory results and it is deemed to have failed, the criticality assistant will execute 50. (Criticality assistant method is discussed in association with FIG. 3F.) If the surveillance fails, the user is presented with a prompt to create a follow-up surveillance 112 in a number of days specified by the client (default is ten days). If the user determines a follow-up surveillance is desired, a new surveillance record is created 112 with a DueDate corresponding to the number of days set by the user. The follow-up surveillance is linked by ID to each other through the “tbl_Links” table in the database.

After creation of a new surveillance record, or if no follow-up surveillance is desired, or if the surveillance did not fail, the client must determine if attachments to the specific surveillance record are desired 1 16. An attachment in virtually any format may be added to each surveillance data file. The attachment will be limited only in file size, which is configurable by the client. This includes, image type attachments which are displayed as clickable thumbnails. If such attachments are desired, the client will be prompted to attach, and will simply attach the file at this point 118. If no attachments are needed or desired, the schedule assistant will execute 48.

With respect to FIG. 3E, following the data entry sequence detailed above, the scheduling assistant will execute 48. The scheduling assistant is a schedule analysis tool built into the schedule engine 12 that will assist a client 22 in better, more efficient and effective management of the scheduled surveillances. The scheduling assistant runs in one of two modes, surveillance monitoring mode, or schedule distribution mode. The client will be prompted after scheduling assistant initialization for the desired mode 120. The surveillance monitoring mode is used to increase or decrease the surveillance frequency for a given schedule. The schedule distribution mode will look at surveillance records for a given time (daily, weekly, monthly, etc.) and will work to redistribute the density calculated.

If client chooses to run the scheduling assistant in surveillance monitoring mode, a test is executed after each completed surveillance 124. In the preferred embodiment, the test will account for the failure rate for a given ConfigurationID over a given period of time configurable by the client (default is three months). If the failure count exceeds a given threshold (configurable on a per ConfigurationID basis by the client) the client is prompted to tighten the pre-set passage constraints for the given ConfigurationID to more narrowly focus the attention of any subsequent surveillance on the failed requirement. A new schedule will be created with a higher reoccurrence rate 130. An alternative embodiment allows the test to also focus on passage counts, and in a similar fashion to the above, loosen the constraints on requirements that show a high passage rate. Upon the completion of either the preferred embodiment test or the alternative embodiment test, the current schedule is split into two new schedules 128, and a new schedule is placed into the newly created gap with a heightened surveillance rate 130.

If the schedule distribution mode is chosen to be executed 120 by the client 20, the schedule engine 12 will determine all upcoming schedules and surveillance records on a time basis (i.e per day, per week, per month, etc.). The schedule engine will then display a graphical representation of the schedule density for that time period 136. The client may then redistribute or redefine the density as needed 138. Following execution of the scheduling assistant in one of its two modes, the criticality assistant is executed.

With respect to FIG. 3F, the criticality assistant determines critical areas based on failure rates. The criticality assistant executes automatically following a failed surveillance (mentioned above). Upon initialization, the criticality assistant will determine the number of failures 140 over a client determined timeframe (default is three months). The criticality assistant then adds a weighted score of this failed area based on the predetermined criticality level assigned to that requirement 142. For example, a requirement to mow a lawn may be weighted lower than a requirement to properly package goods to be shipped, and thus a failure of each will result in the latter having a higher weighted score. Failures are also ranked according to criticality level, such as minor failures, major failures, and critical failures. If the weighted score exceeds a specified threshold 144, it may result in the criticality being upgrade to the next highest level. Alternatively, a certain number of lower level failures may result in the criticality level being increased. For example, eight minor failures may result in one major failure, or five major failures may result in one critical failure. This is all predetermined by the client. If the aforementioned weighted criticality score exceeds the failure threshold, the requirement will be upgraded to a higher criticality level 146. On the other hand, if the weighted criticality score does not exceed the predetermined threshold, that requirement will remain at the same criticality level 148. The criticality assistant ends when all requirements are evaluated in this fashion.

With respect to FIG. 3G, the random sampling assistant is a valuable tool to the client in managing surveillances and requirements therein. This function enables the client to create pass/fail tables that define sample size, and pass/fail counts based on these sample sizes 152. Each minor, major and critical requirement is assigned a separate number. Upon initialization of the random sampling assistant, a pass/fail table is created 150 for each “configuration”, to which a default table may be assigned 154. When a surveillance is due, the client may use the assistant linked to the appropriate surveillance to generate a randomized list of numbers to use as the lot size 156. Finally, the random list is linked against the surveillance 158.

What is claimed is:

1. A method for creating a customized list of scheduled tasks done so within a computer structure comprised of a schedule engine, a database server, a web server and a client machine, said method comprising the steps performed by the schedule engine of:
a. Loading configuration information to the schedule engine;
b. Obtaining all active schedules from the database server;
c. Polling the database server for schedules due;
d. Processing all schedules returned as being due;
e. Generating a surveillance record;
f. Placing said surveillance record in the due table;
g. Polling the database server for any schedule changes; and
h. Propagating changes to the schedule list.

2. A method as in claim 1, wherein the web server executes the following method in its management and scheduling of tasks, said method comprising the steps of:
a. Loading surveillance records from the database server, said surveillance records being previously generated by the schedule engine;
b. Configuring template, said template being configured either from default settings, or from settings arranged by the scheduling entity;
c. Entering the data into the appropriate field with the template;
d. Executing the scheduling assistant, said scheduling assistant aiding the client in managing their scheduled surveillance in a more efficient and effective manner;
e. Executing the criticality assistant;
f. Executing of the random sampling assistant; and
g. Executing of the surveillance method assistant.

3. The method as in claim 2, further comprising steps performed, by user to configure the template, of:
a. Rendering template to the primary client web interface;
b. Populating of the display fields with information obtained from the executed surveillance;
c. Saving the input data as a configuration;
d. Determining from the input data whether a schedule is to be attached to the configuration, and if so then rendering said schedule to the primary client web-interface, populating the predetermined fields rendered from the database, and saving said data as schedule configuration; and
e. Determining if additional records are desired and if so, creating separate field records.

4. The method as in claim 2, further comprising steps performed, when the scheduling assistant is executed in the surveillance monitoring mode, of:
a. Executing a test designed to account for a failure rate for a given input data field over a given period of time;
b. Splitting the newly created schedule; and
c. Creating a new schedule.

5. The method as in claim 4, wherein the test is designed to account for passage rates and loosen the constraints on requirements that show a high passage rate.

6. The method as in claim 2, further comprising steps performed, when the scheduling assistant is executed in the schedule distribution mode, of:
a. Determining all upcoming schedules and surveillance records per unit of time;
b. Displaying a graphical representation of such scheduled and surveillance records on the user web interface; and
c. Refining and redistributing schedule density as desired.

7. The method as in claim 2, further comprising steps performed, when the criticality assistant is executed, of:
a. Determining the number of failures over a unit of time;
b. Determining a weighted score;
c. Determining if weighted score passes or fails based on predetermined limits; and
d. Upgrading failures to higher criticality level.
